(19) United States
(12) Patent Application Publication
(10) Pub. No.: US 2025/0137919 A1
(43) Pub. Date: May 1, 2025

(54) OPTOMECHANICAL TRANSDUCTION SYSTEM FOR PHOTOACOUSTIC SPECTROMETRY

(71) Applicant: COMMISSARIAT A L'ENERGIE ATOMIQUE ET AUX ENERGIES ALTERNATIVES, Paris (FR)

(72) Inventors: Wioletta TRZPIL, Grenoble Cedex (FR); Marc SANSA PERNA, Grenoble Cedex (FR)

(73) Assignee: COMMISSARIAT A L'ENERGIE ATOMIQUE ET AUX ENERGIES ALTERNATIVES, Paris (FR)

(21) Appl. No.: 18/929,773

(22) Filed: Oct. 29, 2024

(30) Foreign Application Priority Data
Oct. 30, 2023 (FR) 2311816

(51) Int. Cl. G01N 21/17; G01N 21/01

(52) U.S. Cl. CPC G01N 21/1702; G01N 2021/0112; G01N 2021/1704

(57) ABSTRACT

An optomechanical system for transducing an optical phase shift movement including a mechanical sensor including a sensor element, the sensor element having an upper face extending mainly into a plane called longitudinal plane, when the system is at rest, the mechanical sensor being intended to receive an acoustic wave to vibrate the sensor element at a vibration frequency. The system moreover includes an optical detector capable of guiding a light radiation substantially parallel to the longitudinal plane, the optical detector having an evanescent field. The vibration of the sensor element modifies the evanescent field of the optical detector and the sensor element is moved along a direction called transverse direction, substantially perpendicular to the longitudinal plane when it vibrates.

### TECHNICAL FIELD

The present invention relates to optomechanical detection using resonant micromechanical and/or nanomechanical structures. It has, as a particularly advantageous application, photoacoustic detection, in particular, for detecting gas. It can in particular be used for photoacoustic spectrometry.

### PRIOR ART

Photoacoustic spectrometry is an analysis technique, making it possible, in particular, to determine the concentration of a gas within a medium. It is based on the following photoacoustic effect: when a modulated light radiation, and in particular a laser radiation, is emitted in a medium containing the gas to be analysed, the species constituting the gas absorbs at least partially this radiation, if this has a wavelength in the absorption range of the species, causing an excitation of the molecules of the species. The relaxation of these excited molecules can occur in several ways, and in particular:
a. By a radiative relaxation causing the emission of a photon,
b. By collision with another molecule, causing a heat emission, or
c. By a chemical event such as a chemical bond rearrangement.

The heat emission due to a collision with another molecule causes, among others, a gas expansion and contraction phenomenon, which generates an acoustic wave. The amplitude of this wave is proportional to the concentration of gas within the medium.

The amplitude of this wave can be measured using different means, and in particular, by a mechanical sensor coupled with capacitive detection means, such a system being commonly called resonant capacitive microelectromechanical system. However, the results obtained in the prior art are not satisfactory. Indeed, to maximise the mechanical detection of the acoustic wave, it is necessary to increase the receiving surface of the wave at the mechanical sensor. In doing so, the bulk of the system increases, which is unfavourable in an optimisation integration logic. Moreover, the air located between the mechanical sensor and the electrode located facing it to enable the capacitive detection is alternatively suctioned by the mechanical sensor during its vibration. This air constitutes a viscous damper for the mechanical sensor. This phenomenon, commonly called “squeeze film effect” cannot be avoided and is very disadvantageous for detection.

Thus, current photoacoustic spectrometry integrated systems do not make it possible to obtain results which are as accurate as sought.

An aim of the present invention is thus to propose an alternative to current integrated systems being able to be used for photoacoustic spectrometry. Preferably, this alternative guarantees a more accurate detection than current integrated systems.

### SUMMARY

To achieve this aim, a first aspect of the invention relates to an optomechanical system for transducing an optical phase shift movement comprising:
a. a mechanical sensor comprising a sensor element, the sensor element having an upper face extending mainly into a plane called longitudinal plane, when the system is at rest, the mechanical sensor being intended to receive an acoustic wave to vibrate the sensor element at a vibration frequency,
b. an optical detector capable of guiding a light radiation substantially parallel to the longitudinal plane, the optical detector having an evanescent field.

The system is characterised, in that the vibration of the sensor element modifies the evanescent field of the optical detector and in that the sensor element is moved along a direction called transverse direction substantially perpendicular to the longitudinal plane when it vibrates.

This, detecting the amplitude of the acoustic wave coming from the excitation of a gas is done using a mechanical-optical transduction system. The system according to the invention thus makes it possible to avoid constraints specific to a capacitive detection stated in the introduction. In particular, the squeeze film effect can be easily limited or even removed, which could not be avoided in the case of a capacitive detection system. The system thus enables an accurate detection of the concentration of a gas. The system moreover has, thanks to this, an improved sensitivity with respect to current detection devices. It makes it possible to detect very low gas concentrations, which is particularly advantageous in certain fields like that of detecting toxic gases.

The present invention thus proposes an accurate and sensitive detection system, while remaining compact.

A second aim of the invention relates to a photoacoustic spectrometer comprising a cavity configured to accommodate at least one gas, the cavity comprising:
a. an optomechanical system according to the first aspect of the invention,
b. a first light source configured to inject a detection radiation into an input of the optical detector of the optomechanical system,
c. detection means capable of detecting the power of the detection radiation at an output of the optical detector,
d. a second light source to inject, into the cavity, an excitation radiation capable of being at least partially absorbed by said at least one gas.

The advantages of the system according to the first aspect of the invention are applied mutatis mutandis to the spectrometer according to the second aspect of the invention.

Moreover, the invention makes it possible to produce a spectrometer making it possible to detect several gases simultaneously, and this, using one single input (an input making it possible to bring the gas into the cavity) and one single output (at the detection means).

### BRIEF DESCRIPTION OF THE FIGURES

The aims, objectives, as well as the features and advantages of the invention will best emerge from the detailed description of an embodiment of the latter which is illustrated by the following accompanying drawings, in which:

FIG. 1 represents the system according to an embodiment of the invention in which the optical detector comprises a waveguide and an optical resonator, and in which the acoustic wave is received by a receiving element leading the sensor element to vibrate.

FIG. 2 is a top view of a system according to the same embodiment as in FIG. 1, comprising, this time, two mechanical sensors and two optical resonators.

FIGS. 3A and 3B illustrate different variants for the position of the sensor element relative to the optical detector.

FIGS. 4A and 4B represent the system according to an embodiment of the invention in which the optical detector comprises a waveguide and an optical resonator and in which the acoustic wave is received by the sensor element.

The drawings are given as examples, and are not limiting of the invention. They constitute principle schematic representations, intended to facilitate the understanding of the invention, and are not necessarily to the scale of practical applications. In particular, the dimensions are not representative of reality.

### DETAILED DESCRIPTION

Before starting a detailed review of embodiments of the invention, below optional features are stated, which can optionally be used in association or alternatively:

According to an advantageous embodiment, the mechanical sensor is connected to a substrate, the substrate having an upper face extending mainly into a plane parallel to the longitudinal plane and located facing the mechanical sensor, the substrate having an opening passing through it fully along the transverse direction, the opening located at least partially facing the mechanical sensor along the transverse direction.

According to an example, the sensor element and the optical detector are disposed side-by-side projecting into the longitudinal plane.

According to an example, the sensor element and the optical detector are disposed facing one another along the transverse direction.

According to an advantageous embodiment, the mechanical sensor comprises a receiving element intended to receive the acoustic wave and to be vibrated by the acoustic wave at the vibration frequency, the mechanical sensor being configured, such that the receiving element vibrates the sensor element at the vibration frequency when it is vibrated by the acoustic wave at the vibration frequency.

According to an example, the receiving element and the sensor element are connected by a junction, the junction being connected to a substrate.

According to an advantageous example, the sensor element comprises a plurality of cantilever beams extending from the junction.

According to an advantageous embodiment, the receiving element, the junction and the sensor element are aligned along a first direction, and when the system is at rest, each of the beams has a first dimension L_{115,X} along the first direction and a second dimension L_{115,Y} along a second direction perpendicular to the first direction and parallel to the longitudinal plane, with L_{115,X}>10*_{L115,Y}, preferably L_{115,X}>20*L_{115,Y}. Typically, L_{115,X} is between 20 μm and 100 μm. Typically, L_{115,Y} is between 100 nm and 500 nm.

According to a preferred example, the receiving element, the junction and the sensor element are aligned along a first direction, and, when the system is at rest, the sensor element has a first dimension L_{110,X} along the first direction and a second dimension L_{110,Y} along a second direction perpendicular to the first direction and parallel to the longitudinal plane, with L_{110,X}≥10*L_{110,Y}, preferably L_{110,X}≥100*L_{110,Y}.

According to a preferred example, the receiving element, the junction and the sensor element are aligned along a first direction, and, when the system is at rest, the sensor element has a first dimension L_{110,X} along the first direction and the receiving element has a first dimension L_{120,X} along the first direction, with L_{110,X}≥0.42*L_{120,X}.

A second dimension L_{120,Y} of the receiving element along the second direction can also be defined. Thus, preferably, L_{110,Y}=L_{120,Y}.

According to an advantageous example, the sensor comprises a second sensor element separated from the sensor element by the receiving element, the second sensor element and the receiving element being connected by a second junction, the second junction being connected to the substrate through anchoring points, the second sensor element, the second junction, the receiving element, the junction and the sensor element being aligned along the first direction, the system having a symmetry plane perpendicular to the first direction, and, when the system is at rest, the sensor element and the second sensor element each having a first dimension L_{110,X} along the first direction and the sensor has a first dimension L_{100,X} along the first direction, with: 2L_{110,X}/L_{100,X}≥0.46. In particular, L_{100,X}=2L_{110,X}+L_{120,X}. f_{anch}=2L_{110,X}/L_{100,X} can be noted. This factor f_{anch} is representative of the positioning of the junction and of the second junction, which separate the receiving element of the sensor element and of the second sensor element. It has been observed that when f_{anch}≥0.46, a significant movement was obtained at the ends of the sensor elements. This makes it possible to maximise the effect of the vibration of the sensor elements on the evanescent field and therefore to improve the detection sensitivity.

According to an embodiment, the sensor element is intended to directly receive the acoustic wave.

According to an embodiment, the sensor element is connected to a substrate by at least one junction. This substrate advantageously does not vibrate when the system receives the acoustic wave. This substrate can be qualified as fixed.

According to an advantageous example, the optical detector comprises an optical resonator and the optical resonator is at least partially housed in the opening.

According to an advantageous embodiment of the spectrometer, the second light source is a laser source and the excitation radiation is a laser radiation having a main wavelength greater than 700 nm.

According to an advantageous embodiment of the spectrometer, the cavity further comprises a conduit configured to bring the acoustic wave to the mechanical sensor. Advantageously, the conduit is also configured to amplify the acoustic wave. It thus has an acoustic resonator function.

The terms “substantially”, “about”, “around” mean, when they relate to a value, “plus or minus 10%” of this value or, when they relate to an angular orientation, “plus or minus 10°” of this orientation. Thus, a direction substantially normal to a plane means a direction having an angle of 90±10° with respect to the plane.

An XYZ system represented in the figures will be used in the detailed description below.

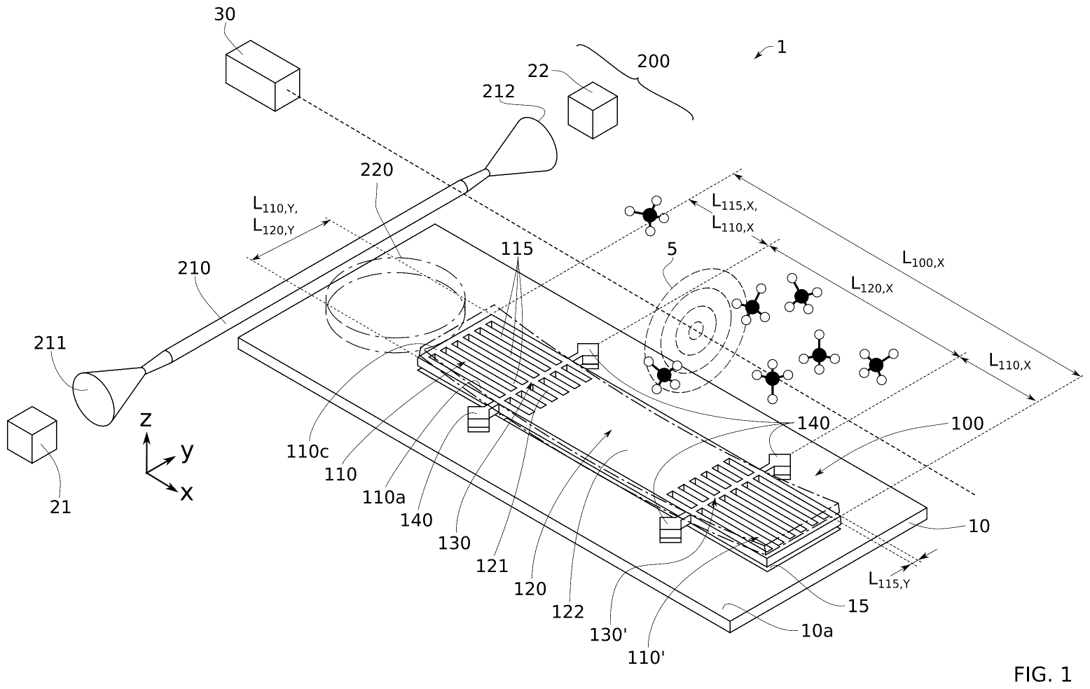

The system 1 according to different embodiments of the invention will now be described in reference to FIGS. 1 to 5.

The elements composing the system 1 can be formed in one same substrate 10, or, for some, can have been deposited on this substrate 10. Certain elements can be formed during same manufacturing steps and be constituted of the same material, for example, silicon or polysilicon. The substrate 10 can, for example, comprise a support substrate 11, typically, silicon-based. A buried oxide layer 12 and an active layer 13 can cover the support substrate 11, the buried oxide layer 12 located between the support substrate 11 and the active layer 13. The different elements of the system 1 described above are advantageously formed in the active layer 13 by conventional microelectronic methods.

The substrate 10 has an upper face 10a extending mainly along a plane called longitudinal plane XY. The longitudinal plane XY is defined by a first direction X and second direction Y perpendicular to one another.

The system 1 comprises a mechanical sensor 100 and an optical detector 200.

The mechanical sensor 100 is intended to receive an acoustic wave 5 so as to be vibrated by this acoustic wave 5 at a vibration frequency.

The structural features (sizing, materials, etc.) of the mechanical sensor 100 are such that the latter is capable of being vibrated in a frequency range. Typically, the mechanical sensor 100 is capable of vibrating in a frequency range comprising a resonance frequency corresponding to a given gas. A person skilled in the art fully understands the way in which such a sensor is produced, such that it can vibrate at a precise frequency, or at least in a frequency range comprising this frequency, and preferably, centred around this frequency. Thus, for example, the mechanical sensor 100 can be designed, such that it is capable of vibrating in a frequency range comprising a resonance frequency f_{CO2} or f_{NH3}, and preferably capable of vibrating at a frequency substantially equal to f_{CO2} or f_{NH3}, corresponding respectively to the frequencies of the acoustic waves emitted following the CO₂ and NH₃ excitation. The vibration amplitude of the mechanical sensor 100 will thus correspond to the concentration of CO₂ or of NH₃, respectively. It must be noted that the frequencies f_{CO2} or f_{NH3} are dependent on the thermal relaxation time of CO₂ and of NH₃, respectively, when these gases are excited by the excitation radiation. These gases are given as examples, but it is understood that these explanations are valid for any gas. It is understood that, although the mechanical sensor 100 is sized to be able to vibrate at the resonance frequency corresponding to a given molecule, the actual vibration frequency of the mechanical sensor 100 cannot be exactly this resonance frequency. The system 1 will be operational, all the same.

The mechanical sensor 100 comprises a sensor element 110 which, when the mechanical sensor 100 receives the acoustic wave 5, is vibrated at the resonance frequency. The sensor element 110 can directly receive the acoustic wave 5 or be vibrated through a distinct region having received this acoustic wave 5 and forming part of the mechanical sensor 100. These two variants will be considered in more detail in the scope of embodiments described above.

The sensor element 110 has an upper face 110a which, when the system 1 is at rest, extends mainly into the longitudinal plane XY. It is understood that the system 1 is at rest when it does not vibrate due to the receiving of an acoustic wave 5. It is thus immobile relative to the substrate 10.

The following paragraphs relate to describing the optical detector 200.

The optical detector 200 typically comprises a waveguide 210, conventionally linear, and an optical resonator 220, for example, ring-shaped—thus, optical ring is referred to—disc-shaped, or more generally, “racetrack” shaped. The waveguide 210 and the optical resonator 220 are coupled by an evanescent coupling.

The waveguide 210 comprises an input 211 and an output 212 between which, when the system is operating, a light radiation, typically a laser radiation, called detection radiation is diffused. The coupling between the waveguide 210 and the optical resonator 220 is such that at least some of the detection radiation is injected into the optical resonator 220, then collected again by the waveguide 210. The vibration of the sensor element 110 in the proximity of the optical resonator 220 causes a modification of the actual optical index of the latter and therefore disrupts the detection radiation passing into the optical resonator 220.

In order to enable the detection of the vibration of the sensor element 110 by the optical detector 200, the optical resonator 220 and the sensor element 110 are positioned, such that at least one part of the sensor element 110 is located in the evanescent field of the optical resonator 220. The distance between the sensor element 110 and the optical resonator 220 can, for example, be around 100 nm. Moreover, the relative arrangement of the optical resonator 220 and of the sensor element 110 is such that when the sensor element 110 vibrates, the distance between these two elements varies and the sensor element 110 remains in the evanescent field of the optical resonator 220.

The optical detector 200 moreover comprises means making it possible to detect the power of the light radiation at the output 212 of the waveguide 210. This power is proportional to the movement of the sensor element 110. The analysis of the evolution of this power thus makes it possible to determine the amplitude of the vibration of the sensor element 110 and its evolutions, therefore the amplitude of the acoustic wave and therefore to determine the concentration of the gaseous species studied in the medium.

The means for detecting the power of the light radiation can, for example, comprise a spectrometer, a photodetector such as a photodiode, or an external laser and interferometric detection means.

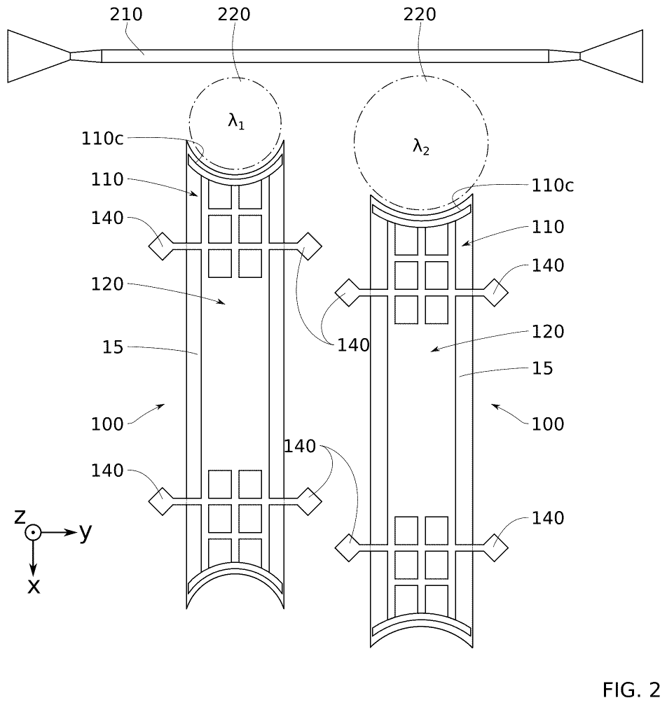

A first embodiment of the system 1 will now be described in reference to FIGS. 1 and 2. It is understood that in FIG. 2, two mechanical sensors 100 appear, but that the system 1 can fully comprise one single mechanical sensor 100, like in FIG. 1, or more than two mechanical sensors 100.

The system 1 comprises an optical sensor 200 such as described above.

In this first embodiment, the mechanical sensor 100 comprises a receiving element 120 intended to receive the acoustic wave 5 and to be vibrated by this acoustic wave 5 at the resonance frequency. This receiving element 120 is configured to, when it vibrates, vibrate the sensor element 110.

Thus, the receiving element 120 and the sensor element 110 are mechanically coupled. For example, they can be connected by a junction 130, itself connected to the substrate 10. The position of the junction 130 defines the coupling between the receiving element 120 and the sensor element 110. The junction 130 can be a beam connected to each of its two ends at anchoring points 140. The beam preferably extends mainly along an axis parallel to the second direction Y, called coupling axis. The beam has the capacity of deforming, twisting about the coupling axis.

According to an advantageous example, the features of the sensor element 110, like for example, its length L_{110,X} along the first direction X, those of the receiving element 120 and those of the junction 130 are such that these three elements 110, 120, 130 together form a mechanism for amplifying the mechanical vibration, meaning that the amplitude of the movement at the flank 110c of the sensor element 110 is greater than the movement amplitude at the main region 122 of the receiving element 120. Such an amplification is, in particular, made possible by a lever arm phenomenon.

According to a variant, in order to enable a good mechanical coupling between the receiving element 120 and the sensor element 110, the receiving element 120 preferably has a perforated region 121 adjacent to the junction 130 projecting into the longitudinal plane XY. More specifically, it is at the perforated region 121 that the receiving element 120 is connected to the junction 130. The perforated region 121 preferably comprises a plurality of beams, each being fixed at an end to the junction 130.

The receiving element 120 preferably comprises a solid main region 122, i.e. not being perforated. Projecting into the longitudinal plane XY when the system 1 is at rest, the receiving element 120 has a closed contour defining a surface Sₜₒₜ and the main region 122 has a surface area S₁₂₂. Preferably, S₁₂₂≥0.5*Sₜₒₜ, and preferably S₁₂₂≥0.9*Sₜₒₜ. The presence of a solid region makes it possible to favour the vibration of the receiving element 120 by the acoustic wave 5.

According to a preferred variant, the receiving element 120 does not comprise a perforated region 121 and is only formed of the solid main region 122. This makes it possible to maximise the mechanical-acoustic interaction between the receiving element and the acoustic wave 5.

Preferably, while the system 1 is at rest, the receiving element 120 and the sensor element 110 are located in the extension of one another along the longitudinal plane XY.

In order to enable a good mechanical coupling between the receiving element 120 and the sensor element 110 and a good mobility of the sensor element 110, the sensor element 110 is preferably perforated and thus has through openings along the transverse direction Z. Typically, the sensor element 110 comprises a plurality of beams 115, for example three, extending from the junction 130. These beams preferably extend mainly along the first direction X, perpendicularly to the main direction of the junction 130. The beams 115 can also be connected to one another by transverse beams, as illustrated in FIG. 2. Such transverse beams make it possible to increase the rigidity of the sensor element 110 and to limit the number of undesirable vibration modes, even remove them.

According to another variant, the sensor element 110 is constituted of one single beam preferably extending mainly along the first direction X.

According to an embodiment, the mechanical sensor 100 comprises one single sensor element 110.

According to another embodiment, as illustrated in FIG. 1, the mechanical sensor 100 can have a symmetry plane perpendicular to the longitudinal plane XY and comprising the second direction Y. This symmetry plane intersects, in particular, the receiving element 120. Thus, typically, the mechanical sensor 100 comprises a second junction 130′ and a second sensor element 110′. The junction 130 and the sensor element 110, on the one hand, and the second junction 130′ and the second sensor element 110′, on the other hand, are located on either side of the receiving element 120. These elements preferably located in the continuity of one another along the first direction X when the system 1 is at rest.

It is understood that although the second sensor element 110 has all the features of the sensor element 110, it is not necessary to associate it with an optical detector. A reading of the vibration of the mechanical sensor 100 at the sensor element 100 is alone sufficient to increase the vibration amplitude and the concentration of the gas analysed. However, the option of including a second optical detector associated with the second sensor element 110 is provided. The presence of two optical detectors can indeed be advantageous.

As is also illustrated in FIG. 1, the mechanical sensor 100 advantageously has a symmetry plane perpendicular to the longitudinal plane XY and comprising the first direction X. This enables a good balance of the mechanical sensor 100 and thus a better detection of the vibration amplitude.

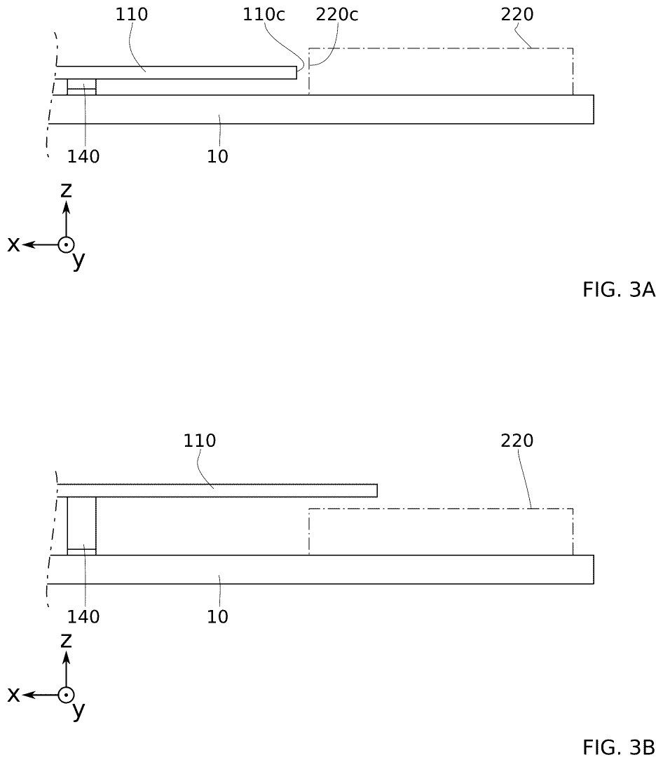

The sensor element 110 can be positioned in different ways relative to the optical resonator 220, as illustrated in FIGS. 3A and 3B.

According to a first example illustrated in FIG. 3A, projecting into the longitudinal plane XY, the sensor element 110 and the optical resonator 220 located side-by-side. The sensor element 110 thus has a flank 110c facing an interaction face 220c of the optical resonator 220. Advantageously, and as illustrated in FIG. 2, the flank 110c of the sensor element 110 located facing the optical resonator 220 has a shape which is complementary to the latter. This makes it possible to maximise the mechanical-optical interaction between the mobile mass 110 and the optical detector 200. For example, when the optical resonator 220 is an optical ring and therefore has a crown shape projecting into the longitudinal plane XY, it is advantageously provided that the sensor element 110 has a concave shape towards the optical resonator 220, i.e. at its flank 110c.

According to a second example illustrated in FIG. 3B, the sensor element 110 and the optical resonator 220 located facing one another along the transverse direction Z. Thus, projecting into the longitudinal plane XY, the image of one is projected onto the image of the other. This embodiment makes it possible to maximise the amplitude of the distance between the sensor element 110 and the optical resonator 220 during the vibration of the sensor element 110. This makes it possible to maximise the effect of the vibration on the evanescent field and consequently, the optomechanical effect. The output signal is greater, and the detection sensitivity is therefore improved.

In this embodiment illustrated in FIG. 3B, the optical resonator is advantageously a photonic crystal. A resonator of this type has a very concentrated, out-of-plane evanescent field (i.e. in this case, along the transverse direction Z). Moreover, the size of the optical resonance of a photonic crystal is comparable to the typically values being able to be given to the width of the beam forming the sensor element 100 (typically, between 200 nm and 1 μm). The system 1 is more sensitive than in the case of a disc-or ring-shaped optical resonator.

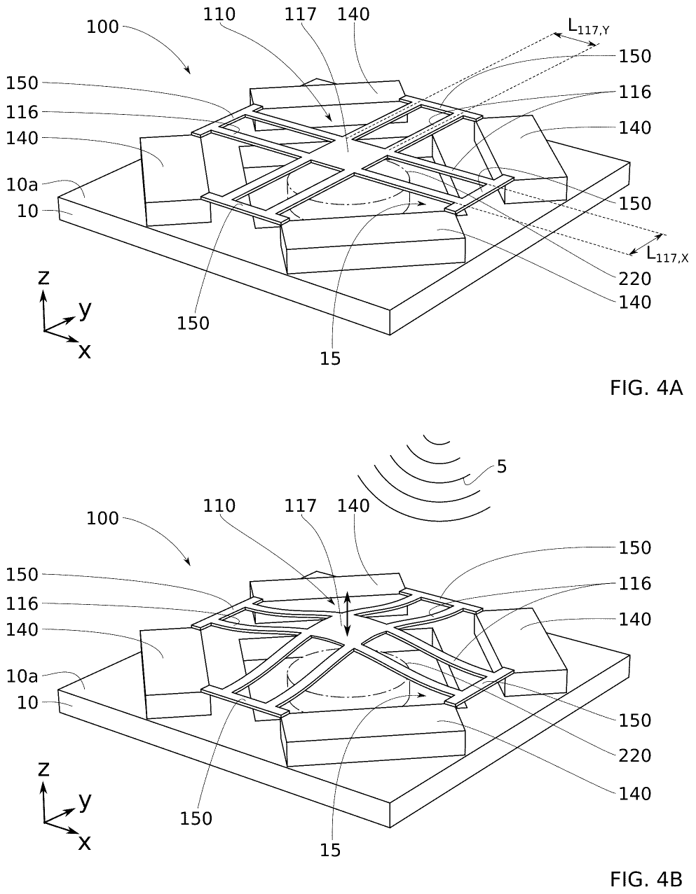

A second embodiment of the system 1 will now be described in reference to FIGS. 4A and 4B.

The system 1 comprises an optical detector 200 such as described above.

In this second embodiment, the acoustic wave 5 is directly received by the sensor element 110. The latter is therefore directly vibrated at the resonance frequency.

The sensor element 110 is advantageously connected to the substrate 10 through anchoring points 140. In the example illustrated, the sensor element 110 is connected to the anchoring points 140 through junctions 150, typically beams. Each junction 150 is connected at each of its ends to an anchoring point 140, about a coupling axis specific to said junction 150. Each junction 150 has the capacity to deform, twisting about its coupling axis.

In order to enable a good mechanical deformation of the sensor element 110 when it receives the acoustic wave 5, the latter is preferably perforated and thus has transverse openings along the transverse direction Z. Typically, the sensor element 110 comprises a plurality of beams 116 extending between the junctions 150 and a central region 117 of the sensor element 110.

In the advantageous example illustrated in FIGS. 4A and 4B, the central region 117 has a rectangular, preferably square shape, projecting into the longitudinal plane XY when the system 1 is at rest. Projecting into the longitudinal plane XY and when the system 1 is at rest, the central region 117 has dimensions L_{117,X} and L_{117,Y} taken respectively along the second direction X and along the excitation direction Y. L_{117,X} and L_{117,Y} are typically each between 1 μm and 1000 μm.

The system 1 comprises four anchoring points 140 and four junctions 150 each extending between two anchoring points 140. Each coupling axis of the junctions 150 is preferably substantially parallel to a side of the central region 117. The sensor element 110 comprises eight beams 116 connecting it to the junctions 150. Two beams 116 connect each side of the central region 117 to the junction 150 located facing when the system 1 is at rest. The beams 116 can each have a length of between 50 nm and 20 μm, this length being measured along the first direction X or the second direction Y according to the orientation of the beam 116.

In this embodiment, the sensor 100 can have a width of between 3 μm and 5000 μm.

As illustrated in FIGS. 4A and 4B, the mechanical sensor 100 advantageously has a symmetry plane perpendicular to the longitudinal plane XY and comprising the second direction Y. As is also illustrated in FIGS. 4A and 4B, the mechanical sensor 100 advantageously has a symmetry plane perpendicular to the longitudinal plane XY and comprising the first direction X. These symmetries are advantageous for resonating the mechanical sensor 100. They are also for attenuating undesired vibration modes.

FIGS. 4A and 4B illustrate a particular example of an embodiment of the sensor element 110, but it is understood that its structure can be different, in particular, the sensor element 110 could comprise another number of beams 116.

In the embodiment illustrated in FIGS. 4A and 4B, the optical resonator is advantageously a photonic crystal. A photonic crystal can indeed have small dimensions, which contributes to reducing viscous losses.

In each of the embodiments of the system 1 described above, it is possible to provide the presence of an opening 15 in the substrate 10 under the mechanical sensor 100. Thus, projecting into the longitudinal plane XY, the image of one is projected onto the image of the other.

This opening 15 is preferably located, along the transverse direction Z, at least partially under the zone of the mechanical sensor 100 receiving the acoustic wave. Thus, in the embodiment described in reference to FIG. 2, the opening is preferably located at least partially under the receiving element 120. Preferably, the opening 15 underlies all of the receiving element 120. Advantageously, still in this embodiment illustrated in FIG. 2, the opening 15 also extends under at least some and preferably all of the sensor element 110. In the embodiment described in reference to FIGS. 4A and 4B, the opening is preferably located at least partially under the sensor element 110. Preferably, the opening 15 underlies all of the sensor element 110.

The presence of such an opening makes it possible to reduce the attenuation of the vibration of the mechanical sensor 100, and thus maximise the detection of the acoustic wave by the system. It makes it possible, in particular, to avoid an air film being formed between the substrate and the mechanical sensor 100, such an air film causing an undesirable viscous damping.

In the case of the embodiment described in reference to FIGS. 4A and 4B, this opening 15 advantageously accommodates the optical resonator 220 of the optical detector 200. This makes it possible to make the system both more compact and more robust.

According to an example being able to be applied to all the embodiments described above, the mechanical sensor 100 can be formed of a non-resonant membrane, for example, made of graphene, coupled with an acoustic resonator.

### System for Detecting Several Mobile Masses

According to an advantageous embodiment, the system according to the invention can comprise a plurality of mechanical sensors 100, each mechanical sensor 100 being placed so as to modify an evanescent field of the optical detector 200.

The system 1 thus advantageously comprises as many optical resonators 220, all coupled with the waveguide 210, as mechanical sensors 100. Each mechanical sensor 100 can thus be associated with an optical resonator 220 to detect a different vibration frequency (see FIG. 2), or all the mechanical sensors 100 can be associated with one same optical resonator 220. The mechanical sensors 100 have different dimensions from one another, in order to each be capable of being vibrated at a distinct vibration frequency.

Whatever the embodiment chosen, a system having several mechanical sensors makes it possible to simultaneously detect several types of gas.

### Photoacoustic Spectrometer Comprising a System According to the Invention

Another aim of the invention relates to a photoacoustic spectrometer comprising a detection system such as described above.

The system 1 can indeed be disposed within a cavity 2 being able to accommodate one or more gases to be analysed (see FIG. 1).

The cavity 2 thus moreover comprises a first light source 21 making it possible to inject a so-called detection radiation into an input 211 of the optical detector 200, as well as means 22 for detecting the radiation at the output 212 of the optical detector 200.

The cavity 2 also comprises a second light source 30 intended to inject into the cavity 2, a so-called excitation radiation making it possible to excite the gas(es) contained in the cavity 2. The second light source 30 is typically a modulable laser source. The modulable character of the source indeed makes it possible to scan the gas to be analysed in a range comprised in its absorption range, typically in an absorption peak.

The excitation radiation, typically the excitation laser, advantageously has a spectral width more reduced than the absorption range of the gas to be analysed. Moreover, the more the laser has a high intensity, the more relaxations of molecules composing this gas will be detected and therefore, the greater the output signal will be.

The radiation of excitation laser generally has a main wavelength comprised in the infrared, typically between 1 μm and 20 μm. In this range, indeed most of the molecules have one single absorption line, which is advantageous for analysing the output signal.

FIG. 1 illustrates an embodiment of the spectrometer in which the first light source 21 and the second light source 30 are distinct. It can however be considered, according to another variant, that these two sources 21, 30 are, in reality, one single and same source. In this variant, the radiation would be parallel to the second direction Y. Whatever the variant chosen, the radiation must be focalised in vertical alignment, along the direction Z, with the receiving element 120, and preferably in vertical alignment with the centre of the main region 122.

According to an example, it is provided that the acoustic waves are driven towards the mechanical sensor 100 (towards the receiving element 120 or towards the sensor element 110, according to the embodiment) by a conduit. In the case of a system comprising several mechanical sensors 100, the presence of several conduits or a conduit having an opening facing each mechanical sensor 100 is provided. The different conduits—or the single conduit—will thus guide and amplify acoustic waves generated by lasers having distinct main wavelengths.

Using a conduit to bring the acoustic waves towards the receiving element 120 or directly towards the sensor element 110 is, in particular, advantageous when the latter has small dimensions. The conduit thus makes it possible to focalise the wave towards the receiving element and maximise the mechanical-acoustic interaction. The choice of resorting or not to a conduit is therefore made mainly according to the dimensions of the receiving element 120 or the sensor element 110.

The invention is not limited to the embodiments described above and extends to all the embodiments covered by the invention.

1. An optomechanical system for transducing an optical phase shift movement comprising:
a mechanical sensor comprising a sensor element, the sensor element having an upper face extending mainly into a plane called longitudinal plane (XY) when the system is at rest, the mechanical sensor being intended to receive an acoustic wave to vibrate the sensor element at a vibration frequency,
an optical detector capable of guiding a light radiation substantially parallel to the longitudinal plane (XY), the optical detector having an evanescent field,
wherein the vibration of the sensor element modifies the evanescent field of the optical detector and wherein the sensor element is moved along a direction called transverse direction (Z) substantially perpendicular to the longitudinal plane (XY) when it vibrates, the mechanical sensor further comprising a receiving element intended to receive the acoustic wave and vibrated by the acoustic wave at the vibration frequency, the mechanical sensor being configured, such that the receiving element vibrates the sensor element at the vibration frequency when it is vibrated by the acoustic wave at the vibration frequency, the receiving element and the sensor element being connected by a junction, the junction being connected to a substrate through anchoring points.

2. The system according to claim 1, wherein the substrate has an upper face extending mainly into a plane parallel to the longitudinal plane (XY) and located facing the mechanical sensor, the substrate having an opening fully passing through it along the transverse direction (Z), the opening located at least partially facing the mechanical sensor (100) along the transverse direction (Z).

3. The system according to claim 1, wherein the sensor element and the optical detector are disposed side-by-side projecting into the longitudinal plane (XY).

4. The system according to claim 1, wherein the sensor element and the optical detector are disposed facing one another along the transverse direction (Z).

5. The system according to claim 1, wherein the receiving element, the junction and the sensor element are aligned along a first direction (X), and wherein, when the system is at rest, the sensor element has a first dimension L_{110,X} along the first direction (X) and the receiving element has a first dimension L_{120,X} along the first direction (X), with L_{110,X}≥0.42*L_{120,X}.

6. The system according to claim 1, wherein the sensor comprises a second sensor element separated from the sensor element by the receiving element, the second sensor element and the receiving element being connected by a second junction, the second junction being connected to the substrate through anchoring points, the second sensor element, the second junction, the receiving element, the junction and the sensor element being aligned along the first direction (X), the system having a symmetry plane perpendicular to the first direction (X), and, when the system is at rest, the sensor element and the second sensor element each have a first dimension L_{110,X} along the first direction (X) and the sensor has a first dimension L_{100,X} along the first direction (X), with: 2L_{110,X}/L_{100,X}≥0.46.

7. A photoacoustic spectrometer comprising a cavity configured to accommodate at least one gas, the cavity comprising:
an optomechanical system according to claim 1,
a first light source configured to inject a detection radiation into an input of the optical detector of the optomechanical system,
detection means capable of detecting the power of the detection radiation at an output of the optical detector,
a second light source to inject into the cavity, an excitation radiation capable of being at least partially absorbed by said at least one gas.

8. The photoacoustic spectrometer according to claim 7, wherein the second light source is a laser source and wherein the excitation radiation is a laser radiation having a main wavelength greater than 700 nm.

9. The photoacoustic spectrometer according to claim 7, wherein the cavity further comprises a conduit configured to bring the acoustic wave towards the mechanical sensor.
